(19) United States
(12) Patent Application Publication
(10) Pub. No.: US 2021/0287282 A1
(43) Pub. Date: Sep. 16, 2021

(54) FINANCIAL PRODUCT MANAGEMENT AND DISCOVERY SYSTEM

(71) Applicant: Seth Anon, Manhattan Beach, CA (US)

(72) Inventor: Seth Anon, Manhattan Beach, CA (US)

(21) Appl. No.: 16/932,125

(22) Filed: Jul. 17, 2020

(51) Int. Cl. G06Q 40/02; G06F 16/9038; G06F 16/9035; G06F 3/01; G06Q 50/00

(52) U.S. Cl. CPC G06Q 40/02; G06F 16/9038; G06Q 50/01; G06F 3/017; G06F 16/9035

(57) ABSTRACT

A financial product discovery system is disclosed, comprising a financial product database configured to store a plurality of financial product information. A user interface module provides each the plurality of financial product information in a window on the user interface provided on the display of the computing device. A communications module receives a gesture or an indicator provided by the user on the user interface of the computing device, while a processor analyzes the gesture or indicator and accepts or denies the financial product displayed to the user via the user interface module. A user portfolio database stores accepted financial products and associates the stored financial products with a user profile. The user may view their stored financial products on a watch list.

### TECHNICAL FIELD

The embodiments generally relate to computer implemented systems for managing investment information.

### BACKGROUND

The U.S. stock market is an aggregation of buyers and sellers of stocks (also called shares), which represent ownership claims on businesses. These may include securities listed on a public stock exchange, as well as stock that is only traded privately. Historically, investment has been done via stock brokerages.

In recent years, the advancement of computing technologies has produced electronic trading platforms, which are operated through a computer software program to place orders for financial products over a network. Various financial products can be traded including stocks, bonds, currencies, commodities, derivatives, and others. The electronic trading platforms stream live market prices on which users can trade and may provide additional trading tools, such as charting packages, news feeds, and account management functions.

Trading financial products often requires the trader to consume large amounts of information related to the details of the product, its trading history, and current market trends in order for the trader to make an informed buying or selling decision. Many systems in the current arts offer only simple analytics and filtering of stock information to ensure the user gets the pertinent information.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to an financial product discovery system, comprising a financial product database configured to store a plurality of financial product information. A user interface module provides each the plurality of financial product information in a window on the user interface provided on the display of the computing device. A communications module receives a gesture or an indicator provided by the user on the user interface of the computing device, while a processor analyzes the gesture or indicator and accepts or denies the financial product displayed to the user via the user interface module. Accepting the financial product saves the financial product to a watch list in operable communication with a user portfolio database to store accepted financial products and associate the stored financial products with a user profile and the watch list.

The system allows users to be randomly or semi-randomly displayed financial products in a window, which they may swipe or otherwise indicate if they approve or deny the financial product. If the financial product is accepted, it will be saved to the users watch list for future interactions. The window contains a plurality of financial product information including current value of the financial product, historical value of the financial product, and market trends. The system may allow users to follow the investment portfolios and watch lists of other users, communicate with other users, and provide a ranking of users based on investment success.

In one aspect, the user interface module provides a plurality of analytics corresponding to the financial product.

In one aspect, the analytics comprise one or more graphs and one or more charts.

In one aspect, the one or more graphs and one or more charts represent historical data related to the one or more financial products.

In one aspect, a gesture module interprets the gesture or indicator provided by the user to determine if the user has accepted or denied each of the financial products.

In one aspect, a ranking module ranks the user on a leaderboard.

In one aspect, the leaderboard lists the most successful users based on saved financial products by each specific user.

In one aspect, a search engine permits the user to search financial products.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the investment information system, according to some embodiments;

FIG. 3 illustrates a block diagram of the communications module, according to some embodiments;

FIG. 4 illustrates a block diagram of the user interaction system, according to some embodiments;

FIG. 5 illustrates a flowchart of the financial product and user matching process, according to some embodiments;

FIG. 6 illustrates a screenshot of the financial product and user matching interface, according to some embodiments;

FIG. 7 illustrates a screenshot of the watch list interface, according to some embodiments; and

FIG. 8 illustrates a flowchart of the matching process and financial product display process performed by the matching engine, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” may relate to any person interacting with the system including financial product traders. The system may also be used by investment portfolio managers, stockbrokers, and other users involved in the buying and selling of financial products.

As used herein, the term “financial product” may relate to stocks, bonds, currencies, commodities, derivatives, and the like which may be bought and/or sold using a network-based trading system. The financial product may be traded using a fiduciary intermediary or bought and sold directly between users of the system.

As used herein, the term “investment portfolio” refers to any combination of financial assets (i.e., financial products) owned, followed, monitored, or “watched” by the user. In some embodiments, the system may provide a watch list interface in addition to an investment portfolio interface. In such, the user may be able to compile a watch list of financial products they are interested in following in addition to a financial portfolio of financial products they have invested in or purchased.

In general, the embodiments provided herein relate to a system for discovering investment product information via a computing device. The system allows the user to interact with various standardized sectors across the financial markets and view individual financial product details. Users are semi-randomly or randomly provided a single financial product or group of financial products on the interface of the application system, and are allowed to input a gesture to accept or deny (i.e., “like” or “dislike”) to provide an indication if they desire to view more information related to the financial product, or to save the financial product to their watch list. The watch list is a collection of financial products which the user has indicated they have an interest in following. In such, the financial products which the user has expressed interest are easily and readily viewable via the watch list. The system may aggregate financial products that the user has indicated they accept into a listing of financial products. The listing allows the user to easily organize financial products and the information thereof. Further, the system may provide a social aspect wherein users may interact with one another, view shared content, view the financial portfolios of other users, and the like.

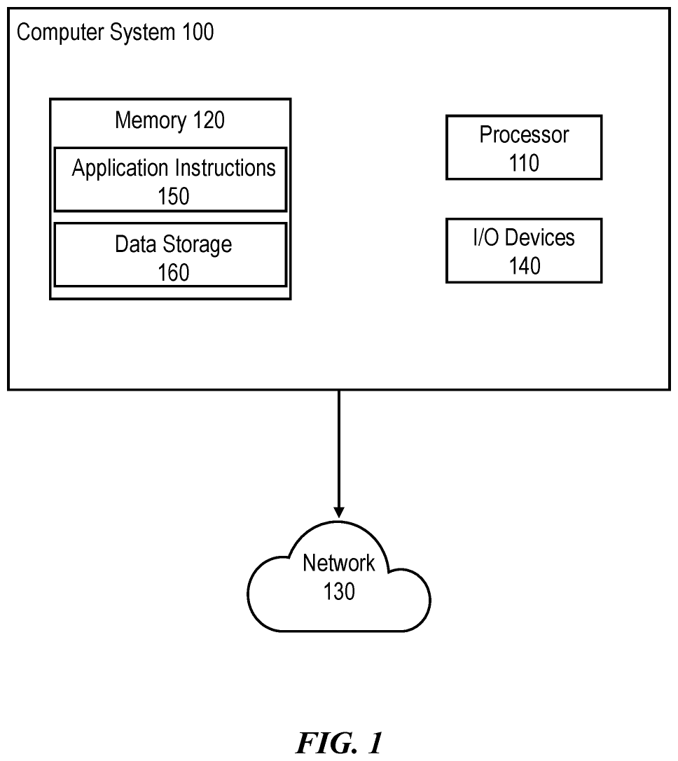

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The memory 120 may be configured to store user profile information, user preferences (including financial product preferences, etc.), gesture preferences (e.g., tap, swipe, etc.), and the like.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

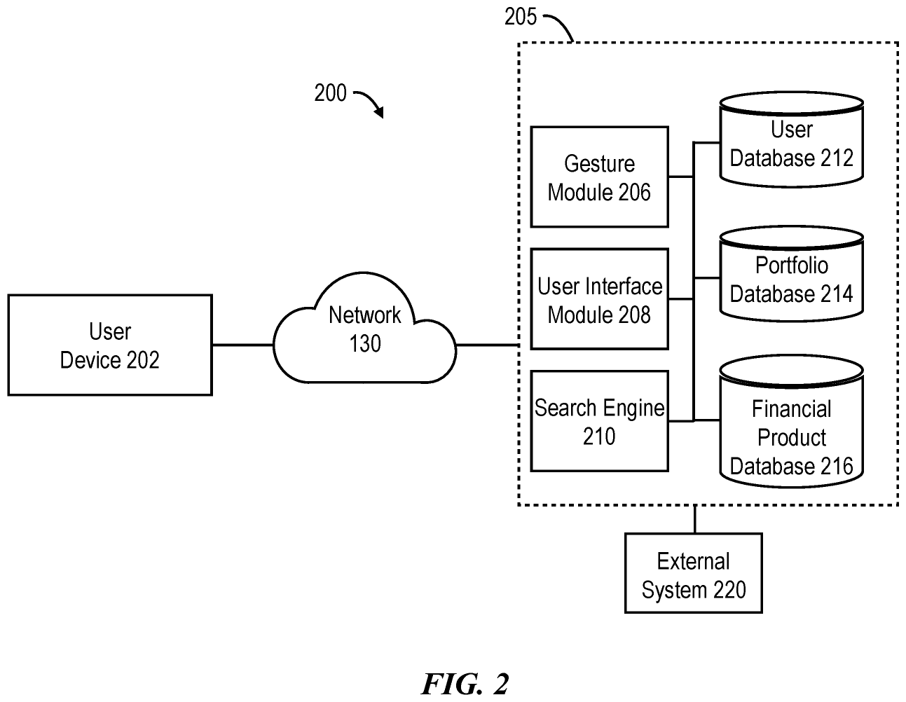

FIG. 2 illustrates a block diagram of the investment information and discovery system 200 having a user device 202 in operable communication with the service provider 205 via the network 130. The service provider 205 comprises a gesture module 206, user interface module 208, search engine 210, user database 212, portfolio database 214, and financial product database 216. The user interface module 208 provides a series of windows including financial product information. The user may then provide a gesture which is interpreted by the gesture module 206 to determine if the user accepts or denies the financial product. The search engine 210 allows user to input a search for a financial product or group thereof. The search engine 210 may also permit the user to input a plurality of filters to input to a search. The user database 212 stores user information including contact details, user profile settings, user financial portfolio settings, user permissions, and the like. The portfolio database 214 stores financial portfolio information and corresponds the financial portfolio information to one or more user profiles. The financial portfolio information may include financial products with which the user interacts, assets owned by the user, and the like. The financial product database 216 stores information related to the financial products with which the users may interact. The external system 220 may include social media systems, communications systems, and the like which may send and/or receive information from the investment information and discovery system 200. In such, the user may share financial products stored on their watch list to a social media outlet.

In some embodiments, the user interface module 208 includes an analytics processor, which provides analytics related to a financial product or group thereof. The analytics may include graphical representations (e.g., historical graphs of financial product values, extrapolations, etc.), data sets, summary data related to the financial product or organization thereof, and the like. Similarly, the user interface module 208 may permit the user to select a timeframe for viewing analytical material. The user interface module 208 may also provide a leaderboard of users which may be generated based on successful trading history, money earned, assets attained, etc.

In some embodiments, once a financial product has received an indication that the user wishes to further interact with the financial product or group thereof, the associated financial product will be stored and associated with the user profile and made available for interaction using the computing device.

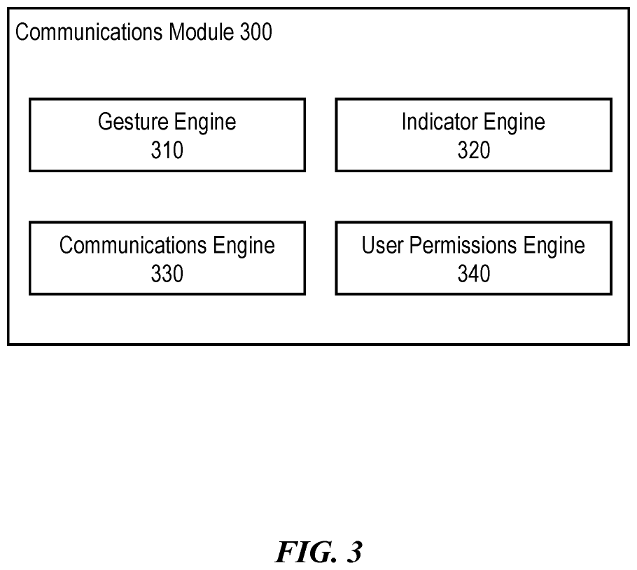

FIG. 3 illustrates a block diagram of the communications module 300 including a gesture engine 310, an indicator engine 320, a communications engine 330, and a user permissions engine 340. The communications module 300 provides a means for permitting the communication between users of the system using a computing device. Users may communicate with one another by “following” each other's information which is provided to the system. For examples, users may indicate they would like to follow other users and view their financial investment history, information contained on a user profile, and the like. The gesture engine 310 permits the user to provide a gesture (e.g., a swipe, tap, or the like) to accept or deny a financial product or group thereof to indicate that the user is interested in adding the financial product to a listing. The listing will allow the user to aggregate financial products in which they have an interest. An indicator engine 320 provides a selectable indicator icon on the user interface to allow the user to accept or deny the financial product or group thereof. In such, a gesture or indicator may be used interchangeably to perform a task. The communications engine 330 processes communications between permitted users such that users can perform general communications functionalities, share financial product information, post information to a public forum, and the like. Communications may include videos, audio, imagery, text, and the like. The user permissions engine 340 modifies user permissions based on user profile type (e.g., a trader, administrative user, fiduciary, financial intermediary, etc.).

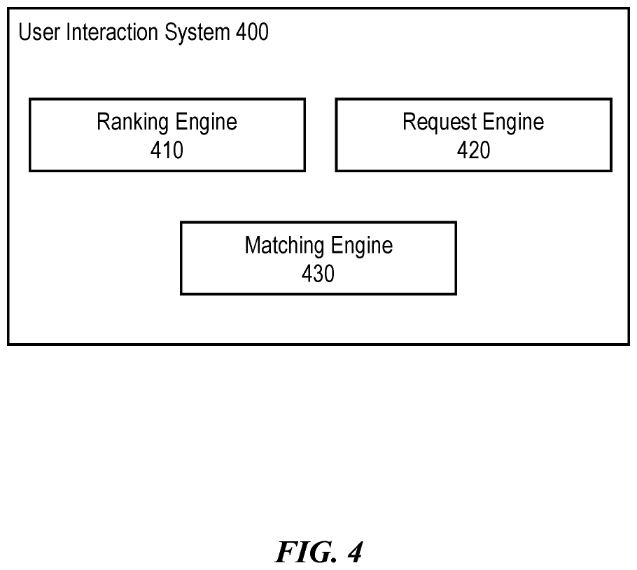

FIG. 4 illustrates the user interaction system 400 comprising a ranking engine 410, a request engine 420, and a matching engine 430. The matching engine 430 provides a user with a plurality of financial products presented in a series of windows with which the user may interact. Each window provides the user the option to accept or deny the financial product. Accepting the financial product results in the information thereof being associated with the user's profile such that the user may then interact with the financial product information, receive status updates of the financial product, and the like. Denying the financial product will result in the financial product window not being presented to the user in the future, unless a new search is made which will reset the pool of financial products used by the matching engine. A request engine 420 allows the user to request to interact with other users of the system. Users may be ranked via a ranking engine 410 which analyzes user performance. User rankings may be generated within predetermined time periods (e.g., the previous 7 days, month, etc.).

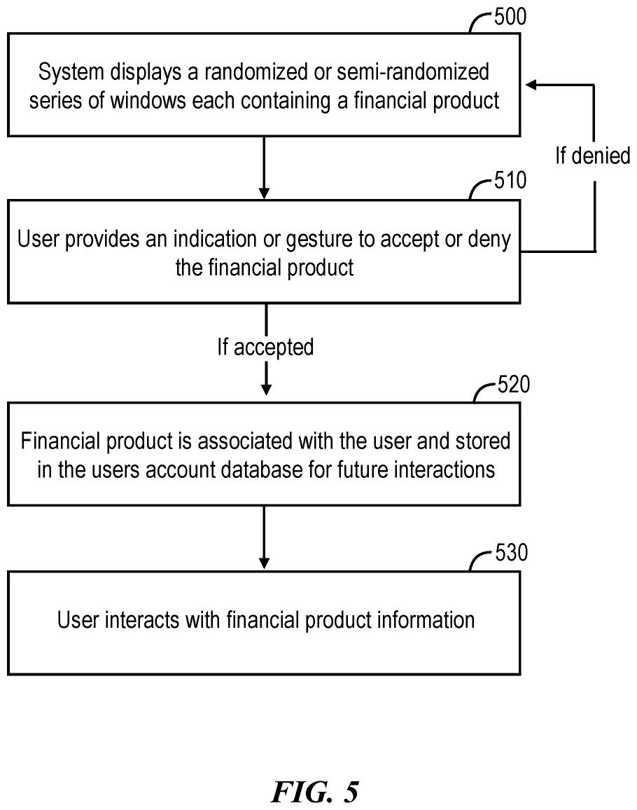

FIG. 5 illustrates a flowchart of the financial product and user matching process wherein the user selectively interacts with financial products and the information thereof In step 500, the system displays a randomized or semi-randomized series of windows, each containing a financial product. Each window may contain data related to the financial product, such as historical data of the trading price of a stock for a particular company. In step 510, the user provides an indication or gesture to accept or deny the financial product. If denied, the user is provided with a subsequent financial product as described in step 510. In step 520, if the user accepts the financial product by either swiping in a predetermined direction or selecting an appropriate icon, the financial product is associated with the user and stored in the users account database for future interactions. In step 530, the user may select to view or otherwise interact with financial product information such as metrics, evaluations, trading history, trading statistics, and the like. Once the user has accepted the financial product which is stored in the watch list, the user is provided with a subsequent series of financial products as described in step 510.

In some embodiments, the method illustrated in FIG. 5 may be utilized for a financial portfolio, wherein the user may swipe or otherwise provide a to save the financial product to the financial portfolio. In such, the user may be prompted to purchase or invest in the financial product which they have swiped or otherwise indicated interest in before or after it is added to the financial portfolio.

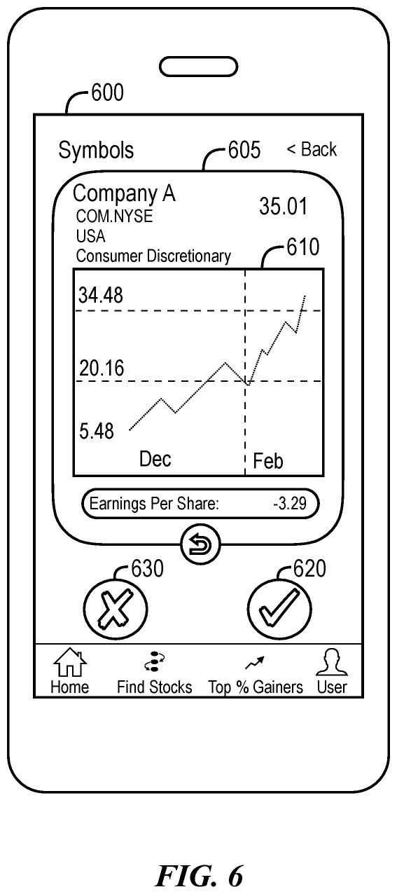

FIG. 6 illustrates a screenshot of the financial product matching interface 600 provided on the display of the computing device. The financial product matching interface 600 includes a company window 605 providing a company name and a financial product information window 610, which may include historical data related to the financial product, the price per share of the financial product, or similar information. The user may be permitted to select the financial product information window 610 to view additional graphs, charts, company summaries and descriptions, financial product summaries and descriptions, and the like. To accept or deny the financial product, the user may swipe the financial product information window 610 and/or the company window 605 to the left (to deny) or to the right (to accept). One skilled in the arts will readily understand that the gesture may be altered to various directions or inputs by the user. Similarly, the user may select an accept icon 620 or deny icon 630.

In some embodiments, the financial product matching interface permits the user to swipe the company window or other portion of the financial product matching interface to save the particular company to a watch list.

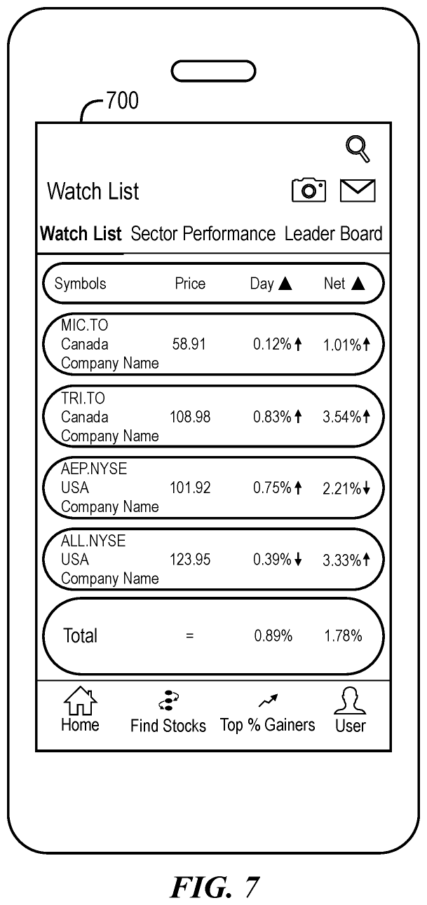

FIG. 7 illustrates a screenshot of the watch list interface 700 which provides a plurality of companies, financial products, or the like which the user has swiped, or otherwise provided a gesture or indicator to indicate they would like to save and further engage with the information thereof. The watch list interface 700 includes symbols, current trading price, and trading metrics (including daily performance, net performance, etc.). The user may utilize the display of their computing device to scroll through, select and interact with information associated with each financial product which is stored and associated with their watch list. Further, the watch list interface 700 includes a total performance window. For example, the total performance window includes a total daily and total net performance. The net change may be calculated from the date each stock was added to the watch list. Total returns may be calculated based on an equally weighted portfolio. A weighted average of intraday total and net total returns may be provided.

In some embodiments, the user may share their watch list, or other information to a social media profile. In such, the user may transmit data from the system described herein, and share information to external information sources, social media outlets, communication systems, and the like.

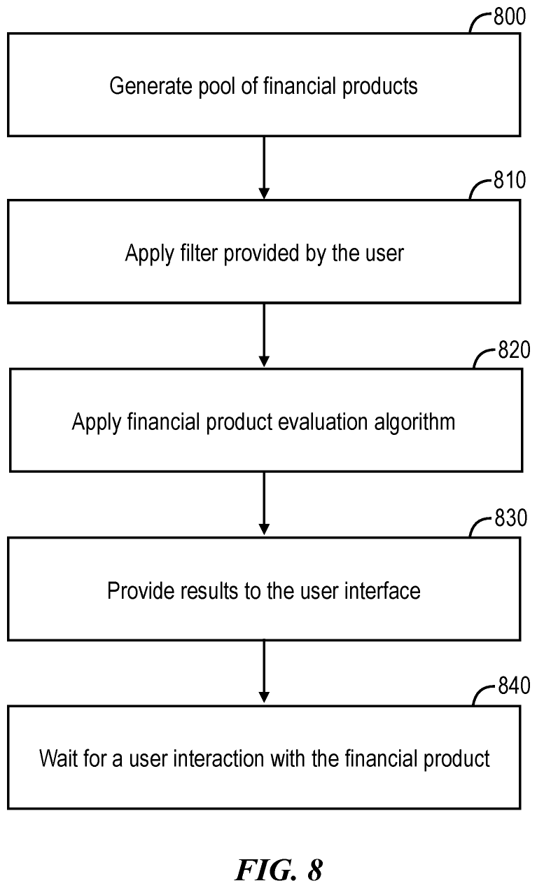

FIG. 8 illustrates a flowchart of the matching process and financial product display process performed by the matching engine described in FIG. 4 hereinabove. In step 800, the matching engine generates a pool of financial products from each of the plurality of financial product stored in the financial products database. The matching engine may apply a filter to the financial products displayed to the user in step 810. In such, the user may apply a filter to view financial products within a specific subset of financial products (e.g., only view stocks and bonds). In step 820 the matching engine may implement a financial product evaluation algorithm, which may evaluate the financial products stored in the database. For example, the financial products that are expected to increase value may be provided to the user first, before high-risk financial products are shown. One skilled in the arts will readily understand that various algorithms may be implemented to adjust the presentation order of the financial products. In step 830, the financial product matching interface provides windows of companies and financial products and waits for a user interaction therewith in step 840.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A financial product discovery system, comprising:
a financial product database configured to store a plurality of financial product information;
a user interface module to provide each the plurality of financial product information in a window on the user interface provided on the display of the computing device;
a communications module to receive a gesture or an indicator provided by the user on the user interface of the computing device;
a processor to analyze the gesture or indicator and accept or deny the financial product displayed to the user via the user interface module, wherein accepting the financial product saves the financial product to a watch list in operable communication with a user portfolio database to store accepted financial products and associate the stored financial products with a user profile and the watch list.

2. The system of claim 1, wherein a secondary gesture permits the user to access additional information.

3. The system of claim 2, wherein the analytics comprise one or more graphs and one or more charts.

4. The system of claim 3, wherein the one or more graphs and one or more charts represent historical data related to the one or more financial products.

5. The system of claim 1, wherein a gesture module interprets the gesture or indicator provided by the user to determine if the user has accepted or denied each of the financial products.

6. The system of claim 1, wherein a ranking module ranks the user on a leaderboard.

7. The system of claim 1, wherein the watch list is transmittable to a social media system.

8. The system of claim 1, further comprising a search engine to permit the user to search financial products.

9. An financial product discover system, comprising:
a financial product database configured to store a plurality of financial product information;
a user interface module to provide each the plurality of financial product information in a company window and a financial product information window, each provided on the user interface provided on the display of the computing device;
a communications module to receive a gesture or an indicator provided by the user on the user interface of the computing device, wherein the gesture is a swipe and the indicator is the selection of one of at least two icons, and wherein the user interacts with historical information corresponding to the financial product;
a processor to analyze the gesture or indicator and accept or deny the financial product displayed to the user via the user interface module, wherein accepting the financial product saves the financial product to a watchlist in operable communication with a user portfolio database to store accepted financial products and associate the stored financial products with a user profile and the watch list.

10. The system of claim 9, wherein the user interface module provides a plurality of analytics corresponding to the financial product.

11. The system of claim 10, wherein the analytics comprise one or more graphs and one or more charts.

12. The system of claim 11, wherein the one or more graphs and one or more charts represent historical data related to the one or more financial products.

13. The system of claim 12, wherein a gesture module interprets the gesture or indicator provided by the user to determine if the user has accepted or denied each of the financial products.

14. The system of claim 13, wherein a ranking module ranks the user on a leaderboard.

15. The system of claim 14, wherein the watch list is transmittable to a social media system.

16. The system of claim 15, further comprising a search engine to permit the user to search financial products.

17. The system of claim 16, wherein the at least two icons comprise an accept icon and a deny icon.

18. The system of claim 17, further comprising an information icon to permit the user to interact with historical financial product information.

19. The system of claim 18, wherein the historical financial product information includes a summary of the financial product.

20. A financial product discovery system, comprising:
a financial product database configured to store a plurality of financial product information;
a user interface module to provide each the plurality of financial product information in a company window and a financial product information window, each provided on the user interface provided on the display of the computing device;
a communications module to receive a gesture or an indicator provided by the user on the user interface of the computing device, wherein the gesture is a swipe and the indicator is the selection of one of at least two icons, and wherein the user interacts with historical information corresponding to the financial product;
a matching engine in operable communication with the communications module, the matching engine to perform the following:
generate a pool of financial products;
apply a filter provided by the user;
apply a financial product evaluation algorithm;
provide results to the user interface, wherein the results include the plurality of financial products; and
wait for a user interaction with each of the plurality of financial products;
a processor to analyze the gesture or indicator and accept or deny the financial product displayed to the user via the user interface module, wherein accepting the financial product saves the financial product to a watch list in operable communication with a user portfolio database to store accepted financial products and associate the stored financial products with a user profile and the watch list.
